(19) United States
(12) Patent Application Publication
(10) Pub. No.: US 2013/0000468 A1
(43) Pub. Date: Jan. 3, 2013

(54) ELECTRONIC CYMBAL

(75) Inventor: Jan Wissmuller, Sarasota, FL (US)

(73) Assignee: ALESIS, L.P., Cumberland, RI (US)

(21) Appl. No.: 13/467,319

(22) Filed: May 9, 2012

Related U.S. Application Data
(60) Provisional application No. 61/502,270, filed on Jun. 28, 2011.

(51) Int. Cl. G10H 3/00

(52) U.S. Cl. 84/723

(57) ABSTRACT

An improved electronic cymbal is disclosed. The electronic cymbal includes a frame having an edge, an upper surface and bottom surface. A cover is received over the upper surface of the frame. A sensor is captured in a pocket in the cover. The cover may include one or more layers.

### CROSS-REFERENCE TO RELATED APPLICATION

This patent document claims priority to earlier filed U.S. Provisional Patent Application Ser. No. 61/502,270, filed on Jun. 28, 2011, the entire contents of which are incorporated herein by reference.

### BACKGROUND

1. Technical Field

The present patent document relates generally to electronic cymbals and more particularly to an electronic cymbal that includes an improved edge sensor assembly.

2. Background of the Related Art

Electronic cymbals of the prior art sometimes include a membrane switch on the edge of the cymbal to detect edge strikes or the act of “choking” (i.e. muting) the cymbal. However, membrane switches are a tough trade-off between being reliably off and requiring too much force to switch on.

Therefore, there is a perceived need in the industry for an improved sensor assembly for an electronic cymbal that reliably detects strikes.

### SUMMARY

The present invention solves the problems of the prior art by providing an electronic cymbal that includes a cover with an integrated membrane switch. More specifically, the electronic cymbal includes a frame having an edge. A cover is attached to the upper surface of the frame. A membrane switch is integrated into the cover and is positioned above the edge of the frame. The cover may include one or more layers or a resilient material, such as rubber, synthetic rubber, silicon, and the like. Because the membrane switch includes resilient material underneath it, the membrane switch is “stiffer” switch (i.e. more robust) and may be triggered without excessive pressure. As a consequence, operation of the membrane switch on the edge of the frame of the electronic cymbal is made more reliable.

### BRIEF DESCRIPTION OF THE DRAWINGS

These and other features, aspects, and advantages of the present invention will become better understood with reference to the following description, appended claims, and accompanying drawings where:

FIG. 1 is a partial side cross-section view of a first embodiment an electronic cymbal made according to the present invention; and

FIG. 2 is a partial side cross-section view of a second embodiment an electronic cymbal made according to the present invention.

### DESCRIPTION OF THE PREFERRED EMBODIMENT

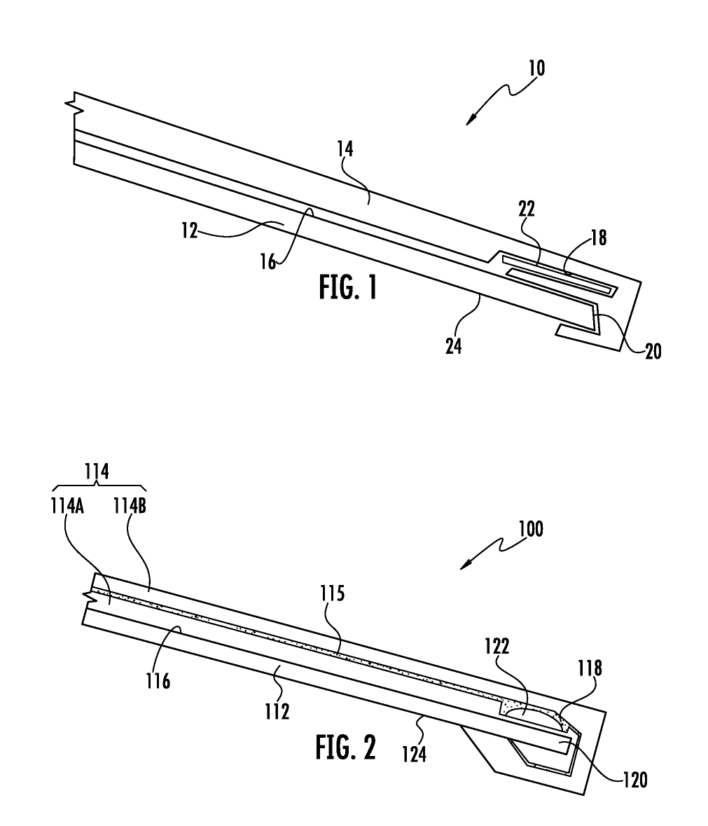

Referring now to FIG. 1, a first embodiment of the electronic cymbal is shown generally at 10. The electronic cymbal 10 includes a frame 12. A cover 14, configured to be struck by the musician, is attached to an upper surface 16 of the frame 12. The cover 14 need not necessarily cover the entire upper surface 16 of the frame 12. The upper surface 16 of the frame 12 may include one of more steps or levels formed in the upper surface 16. The cover 14 includes a pocket 18 formed in the cover 14 above the edge 20 of the frame 12. A membrane switch 22 is placed in the pocket 18 formed in the cover 14.

The cover 14 may include one or more layers or a resilient material, such as rubber, synthetic rubber, silicon, and the like. The cover 14 may wrap around to a bottom surface 24 of the frame 12, but is not essential that it do so.

Referring to FIG. 2, a second embodiment is shown generally at 100, where the membrane switch 122 is captured in a pocket formed between a sandwich of layers 114A, 114B of resilient material that form the cover 114. The resilient material could be rubber, synthetic rubber, silicon, and the like. The layers 114A, 114B are glued together with an adhesive 115 as is known in the art.

The second embodiment 100 includes a cover 114 is formed from hard rubber layer 114A attached to a soft rubber layer 114B. A membrane switch 122 is captured between these two rubber layers 114. Preferably, the hard rubber layer 114A is underneath the softer rubber layer 114B, but is not required. Also, the two rubber layers 114 could be of the same hardness. The term “rubber” is being used loosely herein to refer to any resilient material with rubber-like qualities. A recess, or pocket, 118 may be formed between the two layers 114 therein depending upon the thickness of the membrane switch 122 in order to accommodate the membrane switch 122.

The cover 114 is then attached to the upper surface 116 of the frame 112 of the electronic cymbal 100 like the first embodiment 10. The cover 114 may wrap around to a bottom surface 124 of the frame 112, but is not essential that it do so.

As can be readily appreciate by one skilled in the art, operation of the membrane switch on the edge of the frame of the electronic cymbal 10, 100 is made more reliable by putting a resilient material under the membrane switch 22, 122. The resilient material under the membrane switch 22, 122 (in the proposed envelope 10 or sandwich of layers 100) allows a “stiffer” switch (i.e. more robust) to be triggered without excessive pressure. Either embodiment 10, 100 may be further optimized by profiling the resilient material. For example, a set of saw tooth ridges (axially like bicycle spokes) may be formed on the top or bottom of the resilient material above or below the membrane switch 22, 122 to improve sensitivity by reducing the area exerting the pressure on the membrane switch 22, 122 for closure.

It would be appreciated by those skilled in the art that various changes and modifications can be made to the illustrated embodiments without departing from the spirit of the present invention. All such modifications and changes are intended to be within the scope of the present invention.

What is claimed:

1. An electronic cymbal, comprising:
a frame having an edge, an upper surface and bottom surface;
a cover received over the upper surface of the frame; and
a sensor captured in a pocket in the cover.

2. The electronic cymbal of claim 1, wherein the cover comprises a first layer and a second layer adhered to the first layer, the pocket being formed between the first layer and second layer.

3. The electronic cymbal of claim 2, wherein the first layer is a hard rubber layer.

4. The electronic cymbal of claim 2, wherein the second layer is a soft rubber layer.

5. The electronic cymbal of claim 1, wherein the sensor is a membrane switch.

6. The electronic cymbal of claim 1, wherein the cover overlaps the edge to the bottom surface of the frame.

7. The electronic cymbal of claim 1, wherein the cover includes profiled surfaces adjacent to the sensor.

8. The electronic cymbal of claim 2, wherein the first layer of the cover includes profiled surfaces adjacent to the sensor.

9. The electronic cymbal of claim 2, wherein the second layer of the cover includes profiled surfaces adjacent to the sensor.

10. The electronic cymbal of claim 1, wherein the cover is a resilient material selected from the groups consisting essentially of rubber, synthetic rubber, and silicon.

11. An electronic cymbal, comprising:
a frame having an edge, an upper surface and bottom surface;
a cover received over the upper surface of the frame, the cover having a first layer, a second layer adhered to the first layer, and a pocket formed between the first layer and second layer; and
a sensor captured in the pocket in the cover.

12. The electronic cymbal of claim 11, wherein the first layer is a harder material than the second layer.

13. The electronic cymbal of claim 11, wherein the first layer and the second layer have the same hardness.

14. The electronic cymbal of claim 11, wherein the sensor is a membrane switch.

15. The electronic cymbal of claim 11, wherein the cover overlaps the edge to the bottom surface of the frame.

16. The electronic cymbal of claim 11, wherein the first layer of the cover includes profiled surfaces adjacent to the sensor.

17. The electronic cymbal of claim 11, wherein the second layer of the cover includes profiled surfaces adjacent to the sensor.

18. An electronic cymbal, comprising:
a frame having an edge, an upper surface and bottom surface;
a cover received over the upper surface of the frame, the cover having a first layer, a second layer adhered to the first layer, and a pocket formed between the first layer and second layer; and
a membrane switch captured in the pocket in the cover.

19. The electronic cymbal of claim 18, wherein the cover overlaps the edge to the bottom surface of the frame.

20. The electronic cymbal of claim 18, wherein the cover is a resilient material selected from the groups consisting essentially of rubber, synthetic rubber, and silicon.
